(19) United States
(12) Patent Application Publication
(10) Pub. No.: US 2013/0175840 A1
(43) Pub. Date: Jul. 11, 2013

(54) Chair with Mechanism to Assist Standing Up and Sitting Down for Elderly or Disabled Persons

(71) Applicant: Moran Nadav, Tel Aviv (IL)

(72) Inventor: Moran Nadav, Tel Aviv (IL)

(21) Appl. No.: 13/811,341

(22) PCT Filed: Jul. 21, 2011
(86) PCT No.: PCT/IL2011/000585

§ 371 Date: Feb. 26, 2013

Related U.S. Application Data
(60) Provisional application No. 61/366,190, filed on Jul. 21, 2010.

(51) Int. Cl. A61G 5/14

(52) U.S. Cl. CPC A61G 5/14
USPC 297/313

(57) ABSTRACT

The present invention provides a self-assist chair (100) comprising; a chair frame portion (110), a moveable and tiltable seat portion (150) spaced apart from the horizontal back portion (160), a track (120, 130) and roller (180, 190) system allowing movement of the seat portion (150) of the chair, a spring (200) mechanism connecting the seat portion (150) of said chair (100) and a horizontally moveable part of said chair frame (110) portion. The spring (200) mechanism of the self-assist chair (100) includes a track guided release mechanism responsive to forward movement such that movement of the rollers (180, 190) on the tracks (120, 130) to a preset position releases the spring (200), thereby urging and tilting the seat portion (150) upwards facilitating the exit of a user from a chair (100). Conversely a compressing mechanism is responsive to backward movement of the rollers (180, 190) on the tracks (120, 130) to a preset position compresses the spring (200), urging and flattening the seat portion (150) to a horizontal plane facilitating the entry of a user into a chair (100).

### BACKGROUND OF THE INVENTION

1. Field of the Invention

The present invention relates to the field of chairs, and more particularly to a chair containing a system useful for assisting those with physical limitations in entering and exiting the chair in a natural manner.

2. Background Art

There are many people in the general population with limited physical abilities, including the elderly, and those with restricted mobility due to diseases such as arthritis or due to trauma. For these people and others with special needs, even simple every day activities are complex and require assistance, often from another person or alternatively complex, expensive, unattractive or bulky devices are required.

Movements or activities for which someone with restricted mobility may require assistance include such simple day to day activities as entering and exiting a chair, whether in a private home, old age home, hospital, or in other public and private locations.

Often a person with limited physical capabilities will wait until an able bodied person is available to assist them in getting up from a chair or sitting down in one, thus this simple act becomes dependent on the presence of and ability of another person to assist. When a person with physical limitations is dependant on another to rise or sit, they are highly likely to remain seated, leading to many undesirable psychological and physical side effects, including: loneliness and loss of communication, lack of independence, loss of appetite, depression, lack of exercise and other related conditions such as bed sores, pressure injuries, bone spurs and muscle atrophy associated with remaining in the same position for prolonged periods.

A variety of chairs exist in the market that may assist a person with physical limitations to rise from or sit in a chair, however in many of these cases the chair requires a complex mechanism or a power supply to function or may be unattractive, bulky or expensive. Many elderly and physically limited persons are able to actively rise from or sit in a chair with only a small amount of assistance to lessen the physical burden of this activity, whereas most of the existing chairs completely neutralize the need for the user to exert themselves. In these cases, it is healthier for such a person to have some physical exertion when rising from or sitting in the chair rather than the specially adapted chair doing all the work.

International patent application WO2009147150 A1 discloses a chair adapted to cater for the disabled and encumbered user, in such a way that it does not look substantially different from a normal chair. The chair WO2009147150 A1 is adapted to facilitate ease of entry and exit from the chair by placing the seat in a raised and forward position convenient to the user. The seat is in this forward and raised position when unoccupied, ready for user entry and, when the user sits in the chair, the chair moves into a stable and reclining orientation. Conversely, when the user wants to get out of the chair, forward weight transfer by the user when they get up, enables the spring-like supporting structure to restore the occupied chair towards the easy entry and exit positions. However, the chairs described in WO2009147150 A1 are of a generic nature and include rocking mechanisms, such that the chairs are rocking chairs rather than regular stable chairs suitable for regular use.

Japanese patent JP08000671A2 describes a chair that enables the user to easily sit down in or stand up from a chair without imposing a burden of physical strength on the user by installing a raising machine composed of a spring mechanism and an oil pressure mechanism or similar on the bottom plate of the chair legs. The mechanism in JP08000671A2 contains a shaft that causes the pivoted seat and back of the chair to reach a position that is almost vertical, such that the chair could be said to be almost parallel to the standing user. This chair is a complex mechanism and, moreover, does not look like a regular chair and leaves little physical exertion for the user.

U.S. Pat. No. 4,007,960 discloses a reclining elevator chair, with a tiltable back, extendible leg rest and a means for raising the seat and simultaneously tilting it forward. The movement is provided by a power-driven ram that simultaneously tilts the back and extends and retracts the leg rest. Thus users of the chair disclosed in U.S. Pat. No. 4,007,960, are facilitated in arising from the chair in a totally passive manner, rather than utilizing their physical capabilities.

Japanese patent JP08243122A2 discloses a chair in which the seat and backrest rise up and move forward to enable a patient or user to stand up from the chair or sit down on it without applying a physical burden on the user. In JP08243122A2 the mechanism has 4 connecting rods, 2 on each side placed between the foot poles and the backrest, that are able to pivot at the point of attachment, such that the chair moves upward perpendicularly or at an angle, as the backrest of the chair moves, the seat is also moved, pushing the patient and letting them rise into a natural posture, as a shaft bar is moved in a long groove at the base of the seat of the chair.

JP2004243075A2 provides a chair which assists an aged or physically limited person in seating themselves or arising from the chair in a natural manner, by their own efforts. As the user moves to stand up, they place a foot or feet on a step board, which is located directly between the legs of the chair and which is attached by rods to the levered seat of the chair and pushes the seat up in a tilted manner, thus pushing the user up.

Japanese patent JP2003019055A2 discloses a vertically movable chair that smoothly helps the standing operation of an aged or physically disabled person with weak knees and legs, reducing the burden of rising to a standing position. The chair comprises a foot rest attached to the back of the chair. A driving mechanism pushes the seat back vertically upwards, thus tilting the seat part of the chair forward so as to push the user to a standing position. The mechanism is not dependent on the chair's occupant utilizing their own efforts to stand up.

A further Japanese patent, JP08257062A2, discloses the structure of a chair that allows the user to stand from a sitting position and allows the user to extend their moving range. The backrest of the chair is attached in a pivoted manner to the seat base on each side and when pulled up by the armrests attached to the seat back, the seat of the chair is tilted forward, thus pushing the user to a standing position.

Japanese patent, JP2005218830A2 discloses a chair inclining device for assisting an elderly or physically limited user in standing up from or sitting down in a chair. The chair has a base unit underneath the seat containing a central power transmission shaft that moves a link mechanism to tilt the chair unit, comprising a seat part and a backrest part, either forward to assist in standing up or backward to assist in sitting down. Thus, in this invention, the effort necessary for exiting and entering the chair is derived from an external power source and not from the physical efforts of the user.

International patent application WO9829082A1 discloses a tiltable chair that allows a user that has difficulties in movement to go between a substantially horizontal sitting position and a position tilting forwards for standing up. The chair described in WO9829082A1 comprises two legs, each with a foot at its lower end, connected by a transverse beam. The seat of the chair is further connected to the legs of the chair by a shaft that pivots around the transverse beam. The two tube-like legs of the chair contain vertically placed pressure springs in the form of gas springs that are pushed down as the user sits. The springs are adapted to give a substantial resistance against the lowering movement of the user, such that the user must hold the elbow rests when sitting down; the lifting weight of the springs is ideally between 60-80% of the weight of the user. Furthermore, the back rest follows the declination of the seat forwards in the upper position, so that it provides support as the user prepares to sit down.

Thus there is a long felt need in the field of specialist furniture and equipment for those with restricted mobility for an improved chair for regular use.

### SUMMARY OF THE INVENTION

The present invention relates to the field of chairs and equipment for users with physical limitations. More particularly, the invention discloses a self-assisting chair capable of reducing the weight load of a user upon entry and exit from the aforementioned chair.

It is hence one object of the invention to disclose a self-assist chair comprising; (a) a chair frame portion, (b) a back rest; (c) a moveable and tiltable seat portion, (d) a track and roller system allowing movement of the seat portion of the chair, and (e) a spring mechanism connecting the seat portion of the chair to a horizontally moveable part of the chair frame portion,

It is a core purpose of the invention to provide the spring mechanism including a track guided mechanism responsive to forward movement such that movement of the rollers on the tracks to a preset position releases the spring, thereby urging and tilting the seat portion upwards, facilitating the exit of a user from the chair.

Another object of the invention is to disclose the spring mechanism comprising a spring element selected from the group consisting of a compression spring and an extension spring.

A further object of this disclosure is to disclose the abovementioned invention wherein the tiltable and moveable seat portion is fixable in a position desired by the user so as to prevent further unwanted movement of the seat.

A further object of this disclosure is to disclose the abovementioned invention wherein the fixating mechanism is selected from the group including but not limited to stopper, lever, switch, button, groove or any combination thereof.

A further object of this disclosure is to disclose the abovementioned invention wherein the tiltable and moveable seat portion is attached to a horizontal panel below the seat portion by at least one articulated connection and at least one spring.

A further object of this disclosure is to disclose the abovementioned invention wherein at least one spring is selected from a group consisting of to balance springs, leaf springs, Belleville springs, constant-force springs, gas springs, mainsprings, torsion springs, wave springs, negator springs and helical springs and any combination thereof.

A further object of this disclosure is to disclose the abovementioned invention wherein at least one spring is located at any position between the seat panel and horizontal panel beneath, including randomly distributed positions, diagonal rows, front to back rows, side to side rows, at the corners of the seat or any combination thereof.

A further object of this disclosure is to disclose the abovementioned invention wherein the seat portion, back rest and arm rests are covered in an ergonomic cushioning material, preferably egg crate foam cushion, so as to prevent pressure sores.

A further object of this disclosure is to disclose the abovementioned invention wherein the seat portion, back rest and arm rests are covered in any conventional fabric for the comfort of the user.

A further object of this disclosure is to disclose the abovementioned invention wherein the fabric is breathable.

A further object of this disclosure is to disclose the abovementioned invention wherein fabric is stretchable.

A further object of this disclosure is to disclose the abovementioned invention wherein the track and roller mechanism are hidden from view on each side by a side panel.

A further object of this disclosure is to disclose the abovementioned invention wherein the interior and exterior side panels, legs and other rigid portions of the chair are made from any material that can be laser cut or cut by any other means, including wood, wood derivatives, aluminum, plastic or any combination thereof.

A further object of this disclosure is to disclose the abovementioned invention wherein the seat portion is movable away from the seat back along a first track using at least one pair of attached rollers, and the attached panel moves in a horizontal plane along a second track using at least two pairs of attached rollers.

A further object of this disclosure is to disclose the abovementioned invention wherein at least 2 anterior cushioned and upholstered portions, joined in series to the seat portion, are movable along the second track so as to allow the seat portion to move forward and tilt, while providing protective padding to the user.

A further object of this disclosure is to disclose the abovementioned invention wherein the seat portion is movable upward along the first track while the attached seat panel is movable in a horizontal plane away from the back rest of the chair as affected by the spring mechanism.

A further object of this disclosure is to disclose the abovementioned invention wherein the seat portion is driven by the spring mechanism into a position at an angle of between about 0° and 90°, but preferably between about 40° and 70°, from the horizontal panel.

A further object of this disclosure is to disclose the abovementioned invention wherein a supporting force applied to the user by the seat portion is in a range between about 200 N and about 800 N when the user stands up from or sits down into the chair.

A further object of this disclosure is to disclose the abovementioned invention wherein the supporting force is adjustable by the chair's user.

A further object of this disclosure is to disclose the abovementioned invention wherein the back rest is hinged to the seat portion and loosely anchored to the frame portion such that the back portion and back rest are displaceable in a swinging manner when affected by the spring mechanism.

A further object of this disclosure is to disclose the abovementioned invention wherein the back rest is anchored by a rod mechanically connected to the frame portion; at least one elongate ear accommodating the rod is connected to the back rest at a reverse thereof such that the back rest is slidably displaceable relative to the rod.

A self assisting chair having a frame, a seat portion with at least 2 connected articulated panels in the anterior portion of the seat, a backrest portion and supporting legs, is provided with a spring mechanism activated by the movement of portions of the chair which rest on rollers guided by pre-determined tracks, wherein the self-assisting chair lowers the weight load on the user by at least 40 kg.

A further object of this disclosure is to disclose the abovementioned invention wherein the seat section is movable between a stationary position and an entry and exit position.

A further object of this disclosure is to disclose the abovementioned invention wherein the self-assisting chair conforms to safety standards for determination of stability according to ISO 7174-1-1988.

A further object of this disclosure is to disclose the abovementioned invention wherein the self-assisting chair conforms to safety standards for determination of stability according to ISO 7174-2-1992.

A further object of this disclosure is to disclose the abovementioned invention wherein the self-assisting chair conforms to the standards of Business and Institutional Furniture Manufacturer's Association (BIFMA) standards BIFMA X5.1-2002 for testing of commercial-grade chairs.

A further object of this disclosure is to disclose the abovementioned invention wherein the self-assisting chair conforms to the standards of BIFMA standards BIFMA X5.4-2005 for testing of lounge chairs.

A further object of this disclosure is to disclose the abovementioned invention wherein the self-assisting chair conforms to the standards for a continuous use 24 hour chair.

A further object of this disclosure is to disclose the abovementioned invention wherein a method of assisting a physically limited user in attaining a sitting position or exiting from a sitting position is disclosed. The aforesaid method comprises the steps of; (a) providing a specially adapted chair, the chair further comprising (i) a moveable and tiltable seat portion, (ii) further moveable portions connected to the seat portion, (iii) tracks to guide the movement of sections of the chair along rollers, (iv) a back rest; (v) a spring; (b) supporting the user by applying a supporting force to the user by the seat portion in a range between about 200 N and about 800 N when the user stands up from or sits down into the chair.

The step of supporting the user is performed by the tilting and sliding motion of the seat portion as affected by the released spring.

### BRIEF DESCRIPTION OF THE DRAWINGS

The invention is herein described, by way of example only, with reference to the accompanying drawings. The particulars shown are by way of example only and for the purposes of illustrative discussion of the preferred embodiments of the present invention only. The description taken with the drawings should make apparent to those skilled in the art how several forms of the invention may be embodied in practice.

In the drawings:

FIGS. 1 to 4 are pictorial illustrations of the chair according to the first embodiment of the invention;

FIGS. 5 to 8 are pictorial illustrations of the chair according to the second embodiment of the invention; and

FIG. 9 is a pictorial illustration of the chair according to the third embodiment of the invention;

### DETAILED DESCRIPTION OF THE PREFERRED EMBODIMENTS

The present invention solves many of the problems of current furniture and equipment for those with restricted mobility by providing a chair with a mechanism that facilitates entering and exiting of the chair in a product which is simple to use and assemble, with very few mechanical parts, that requires no external power supply beside that provided by the physical force of the user and which is comfortable and esthetically pleasing to the user. The chair of the present invention utilizes the physical capabilities of the user, afterwards returning to position by itself.

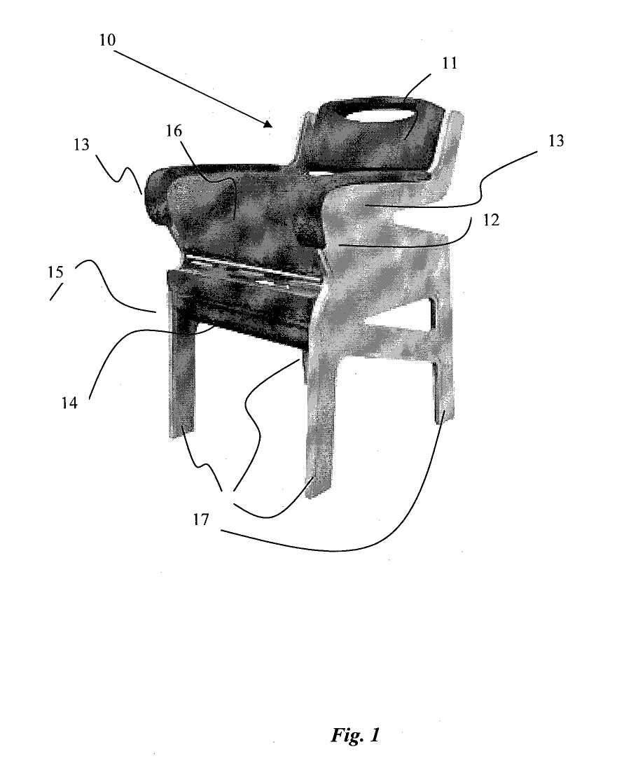

Reference is now made to FIG. 1 illustrating a novel chair 10 which is a first embodiment of the present invention. The chair comprises an upholstered seat back 11, exterior side panel 12, on the top of the side panels are arm rests 13. The lower portion of the side panels are used to construct the four legs 17 of the chair. At the front of the chair are placed a plurality of moveable and slideable panels, preferably between 2 and 4 front panels. In FIG. 1, two front panels, 14, 15 move in conjunction with the tiltable seat 16 of the chair. The seat of the chair is not attached in its posterior portion to the back rest of the chair or to another portion of the chair so as to be easily moveable.

In a further embodiment specific sections of the chair including the back rest 11, arm rest 13, moveable panels 14, 15 and seat 16 are cushioned and upholstered in a fabric or any material suitable for covering a chair, but preferably in a fabric that is stretchable or breathable or both. The aforementioned fabric or upholstery or upholstery stuffing can be of any conventionally used type, synthetic or natural, or combination of both, conforming to any conventional standards such as dye fastness, u/v resistance, color, washability, anti-static tendency, thermal parameters, waterproofing, fire proofing, and any other standard according to the intended use. The upholstery may be of any type used for cushioning in chairs but is preferably an egg crate foam type, useful for reducing and alleviating bed sores. The fabric and/or upholstery may have single use disposable components in some embodiments of the invention. Also in this embodiment the moveable front panels 14, 15 and seat 16 are preferably joined by an exterior fabric enclosing all the moveable upholstered panels together. Thus, in this embodiment, the novel chair is both ergonomic and comfortable for the user due to the cushioning and the breathable fabric, as well as being aesthetically pleasing. In a further embodiment of the present invention, the exterior side panels 12 are placed so as to hide the mechanism of the tiltable and moveable chair seat thus providing the chair with the appearance of a regular aesthetically pleasing chair.

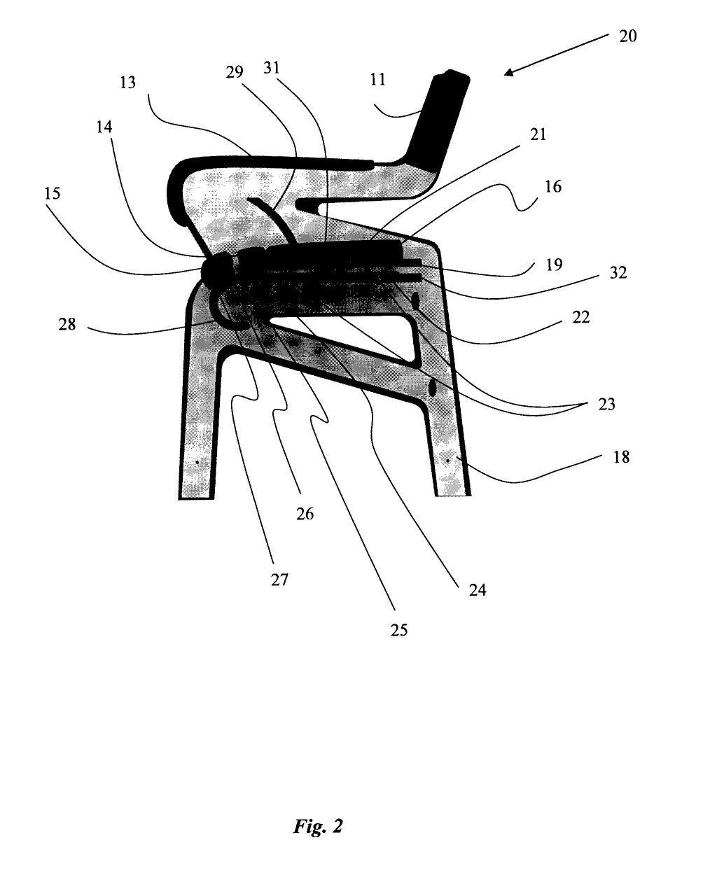

FIG. 2 shows a side view of the chair with the exterior side panel removed to expose the mechanism of the chair of the present invention. In this embodiment the chair 20 is in the resting position, which is the position when the user is seated and not yet attempting to exit the chair or when the chair is not in use. In this embodiment, the interior side panel 18 is prepared so as to contain tracks 19, 28, 29, 32 to enable the movement of specific components of the chair. The tracks can be accurately cut with lasers into the aluminum panels that constitute the interior side panels 18. Also in this embodiment the rollers 21, 23, 25, 27 provided for the different moving parts of the chair are standard rollers that are easily and cheaply obtainable. Thus the production process of the chair is simplified by the standard parts used in its construction.

In a further embodiment of the present invention, the exterior side panels, chair frame portion and interior side panels on which the tracks are laid are made of any material suitable for regular chair construction, but especially materials that can be cut using lasers to simply and precisely form tracks in the panels. Thus, in this embodiment, the non-upholstered portions of the chair, including the exterior 12 and interior 18 side panels and chair frame portion including the legs 17 are composed preferably of wood, wood derivatives, aluminum or plastic, or any combination thereof.

The seat 16 of the chair has one roller 21 on each side of the chair that move along a horizontal track 19 or a diagonally upward curving track 29, depending on the position of the chair. Directly below the seat and on a parallel plane there is a panel 22 that extends to either side of the chair, on which are placed a pair of rollers 23 on each side of the panel, one being towards the posterior of the panel and one towards the anterior, and that move along a track 32. At least one spring 31 is placed between the seat and the panel below it, joining the seat and the panel below together. The at least one spring is positioned so as optimally distribute the weight load. Thus, for example, the at least one spring may be placed at the center of the panel; or in a row either diagonally, front to back direction of the chair or side to side direction; or optionally on each or some of the four corners of the panel and seat; or randomly. In this embodiment the springs used in the chair may be of different types, including but not limited to balance springs, leaf springs, Belleville springs, constant-force springs, gas springs, mainsprings, torsion springs, wave springs, negator springs and helical springs. Also in this embodiment more than one spring type may be used in combination. The cushioned and upholstered front panels 14, 15 are also attached to panels 24, 26 and one roller 25, 27 is placed on one side of each of the articulated panels. The articulated panels move along a track 28 that is cut so as to be curving downwards.

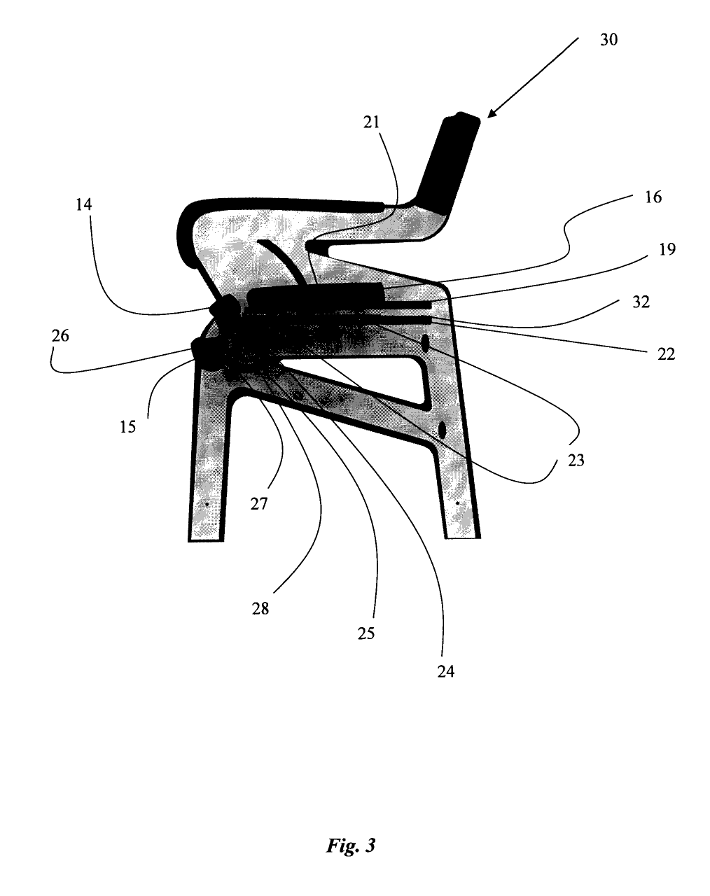

Reference is now made to FIG. 3, showing the chair 30, with the seat at a slightly forward position, as would occur at the initiation of the movement to exit the chair or towards the end of the movement for entering the chair. In this embodiment, the seat 16 portion of the chair and the panel 22 attached directly below it by the spring 31 have moved together in forwards direction along their respective tracks 19, 32, using rollers 21, 23. The adjoining, articulated panels 24, 26 and the upholstered cushion panels attached to them 14, 15 have also moved forward and downward along track 28 using rollers 25, 27, such that the panel 26 and cushion 15 are almost underneath the seat and the panel 24 and attached cushion 14 are at the front of the chair, behind what would be the users' knees. In this embodiment the plurality of articulated panels 24 and 26 are encased in one continuous fabric with the seat portion, preferably a stretchable fabric, thus protecting the user from trapping fingers, limbs, skin or any other body portion between the segments of the articulated panels.

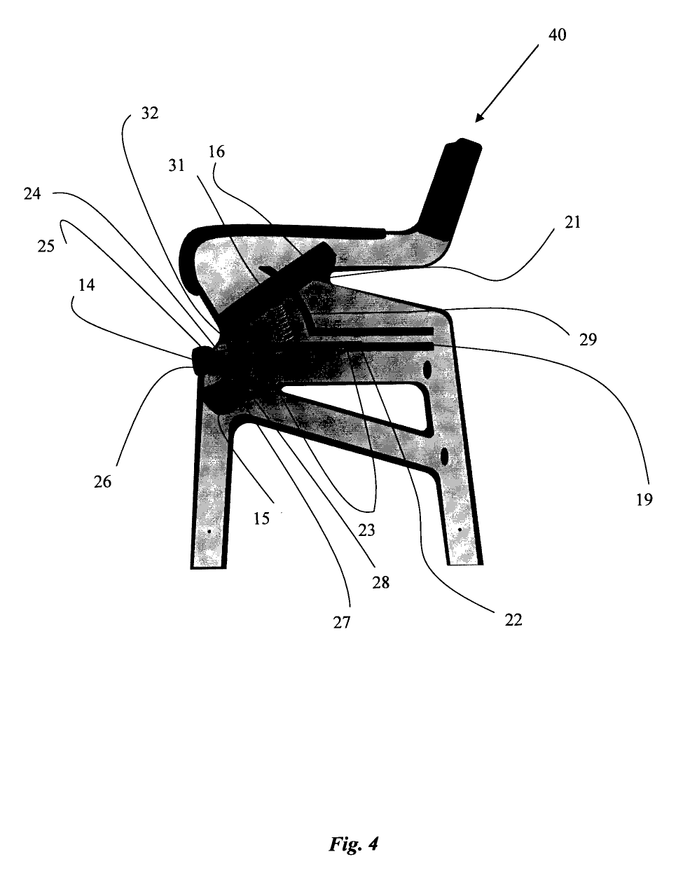

FIG. 4 illustrates the chair 40 of the present invention in the position attained when the user has just exited the chair or just prior to entering the chair. In this embodiment, roller 21, has reached track 29 releasing the spring 31 connecting the seat and the panel 22 below via an articulated connection 32, such that the seat is now at an angle of between 0° and 90°, but preferably between 40° and 70° to the horizontal panel to panel 22. The force exerted by the spring is useful in assisting the user in exiting the chair. Articulated panels 24, 26 adjoining the seat of the chair and the attached cushioned and upholstered panels 14, 15, move further along track 28 on rollers 25, 27, such that panel 15 is now on the underside of the chair and panel 14 is at the approximate location of the back of the knees of the user. In this embodiment the movement of panels 14, 15 allow the forward and upward movement of the seat 16 and its attached panel 22. Also in this embodiment cushioned panel 14 provides protection and support for the user as they enter or exit the chair, preventing a fall or pressure from the sharp edges of the chair.

It is a further embodiment of the present invention, that the chair contains a mechanical spring system which mimics the movement made by humans when arising from and sitting in a chair. The seat of the chair on which the users' buttocks rest is movable and is separate from the back of the chair. The seat portion moves on a pair of rollers that move along a horizontal track on each of the two side panels of the chair.

In a further embodiment of the present invention, the aforementioned mechanism of the chair removes approximately 40 kg of the body weight load from the user, making the process of rising from the chair an active process which is safe and which places less strain and load on the user's body. In a further embodiment of the present invention the aforementioned mechanism can remove between 20 and 80 kg of weight load from the user. In this embodiment, the amount of weight load removed from the user is pre-adjustable on the chair, according to the weight of the user and the user's physical limitations. Thus, for example, a user who weighs 50 kg and is only slightly limited in their movements may adjust the chair to remove only 20-30 kg of weight load, whereas a user that weighs 100 kg and has more severe movement limitations may wish to adjust the weight load removal setting to 70-80 kg.

It is a further embodiment of the present invention that, when the user wishes to sit down, the seat is in a diagonally upwards direction as shown in FIG. 4, and the body weight of the user then pushes the springs down, allowing a gradual, steady and supported entry into the chair. In this embodiment, as the user pushes the spring 31 down, the rollers 21, 23, 25, 27 glide along the tracks 19, 28, 29 to smoothly and safely push the seat chair towards the seat back and thus allow the user to easily return to a full sitting position, with the user's back moved towards the back of the chair.

In a further embodiment, a stopper mechanism is located on the chair of the present invention in a place convenient for the user to reach when sitting. Once the user has reached the desired position in the chair after entering the chair and sliding back towards the chair back, the stopper mechanism can be activated by the user to prevent sliding movement of the seat portion of the chair and to fix it in position. The stopper mechanism can then be easily released when the user wishes to exit the chair. The stopper mechanism may be activated by a lever, switch, button, groove or any other mechanism capable of fixing the seat in a set position.

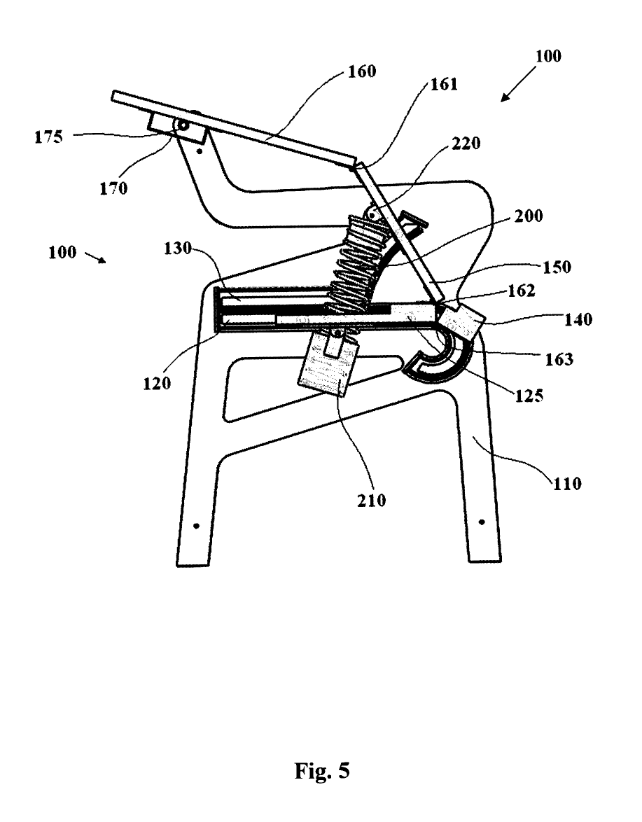

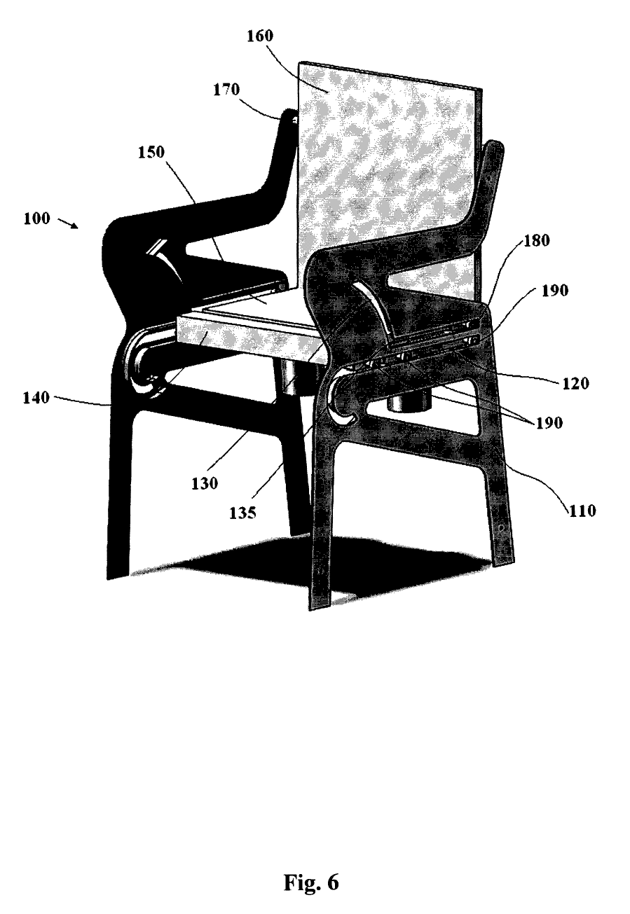

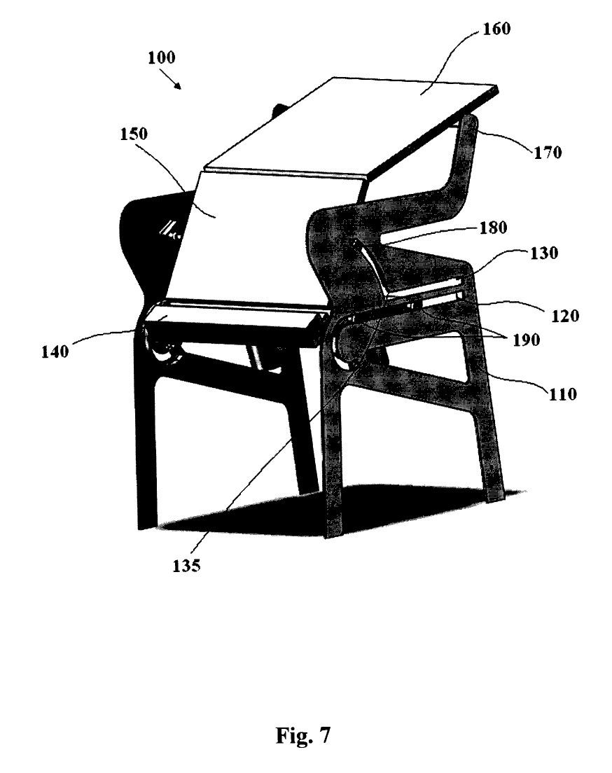

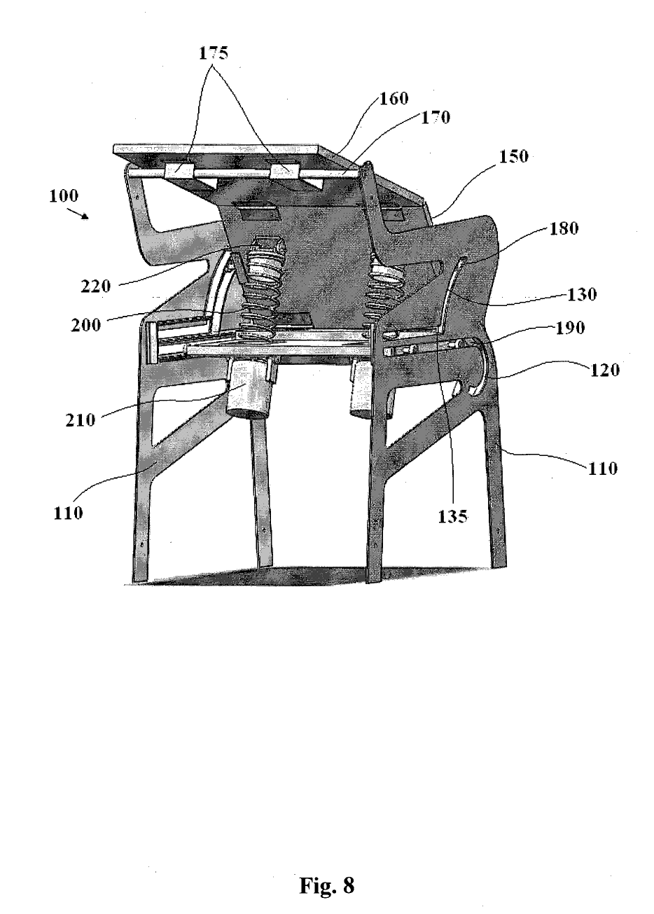

Reference is now made to FIGS. 5 to 8 presenting a second embodiment 100 of the current invention. The chair 100 comprises two spaced-apart frame members 110 rigidly interconnected therebetween. The frame members 110 are provided with first tracks 120 and second tracks 130. An anterior supporting member 140 and a horizontal panel 125 are interconnected by means of a hinge 163. The aforesaid elements 140 and 125 are provided with rollers 190 (shown in FIGS. 6 to 8) configured for travelling along the first track 120. A seat portion 150 is mechanically connected to the horizontal panel 125 by means of a hinge 162. A back rest 160 is connected to the seat portion by means of a hinge 161. Additionally, a reverse of the back rest 160 is provided with at least one elongate ear 175. The aforesaid ear 175 accommodates a rod 170. The back rest 160 which is hinged to the seat portion 150 is forced against the rod 170 by the gravity force and is able to move over the rod 175 in a sliding manner. The horizontal panel 150 and the back rest 160 are interconnected by means of a spring 200 provided with end member 210 and 220 at terminals thereof. Thus, the elements 150 and 160 are configured for swing movement as affected by the spring 200.

The chair 100 operates as follows. When the user sits in the chair 100, the chair arrangement is depicted by FIG. 6. Then, to stand up, the user sitting on the seat portion 150 advances such that the rollers 190 travel along the first track 120 and roller 180 travels along the second track 130. When the roller 180 gets to a point 135, the track 130 allows the seat portion 150 to be angularly displaced upward around hinge 162 as affected by the spring 200. The seat portion 150 and the back rest 160 move in a swinging manner. The release spring assists the user to stand up, by this means supporting the user during standing up and sitting down. The back rest 160 is loosely anchored to the rod 170 by the ears 175. Simultaneous movement of the elements 150 and 160 provides to the user a greater sensation of self-security in comparison with the embodiment depicted in FIGS. 1 to 4.

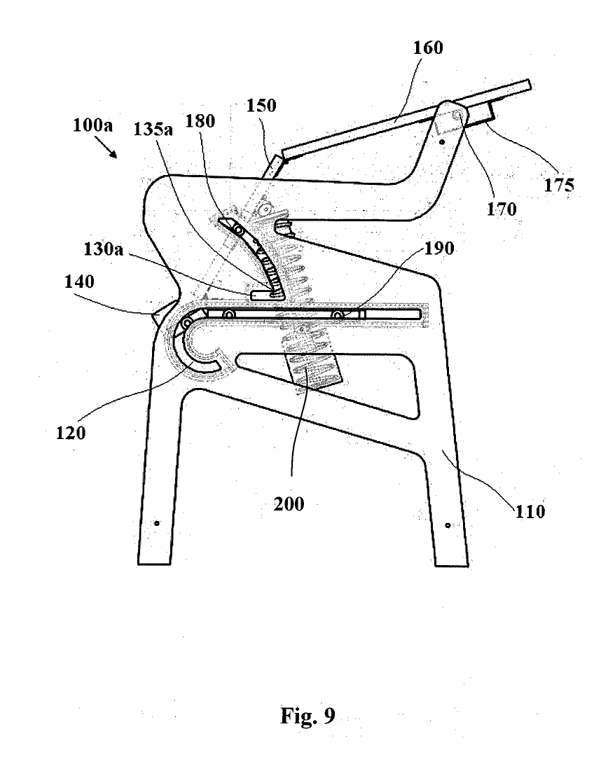

Reference is now made to FIG. 9, presenting a third embodiment 100a. Contrary to the embodiment 100, the chair is actuated by displacement of the seat portion backward. The user sitting in the chair shifts backward. When the roller 180 gets to a point 135a, the track 130 allows the seat portion 150 to be angularly displaced upward around hinge 162 as affected by the spring 200. It should be emphasized that then, when the seat portion and the elements 150 and 170 perform a swinging movement, the horizontal panel moves in the opposite direction (forward).

It is a further embodiment of the present invention that the chair conforms to all safety standards for regular and special use chairs. In this embodiment, the self-assist chair of the present invention conforms to ISO 7174-1-1988 for upright chairs and stools including chairs with tilting, reclining and adjustable back-angle mechanisms when used as upright chairs. The standard gives suggested minimum overturning forces applicable to all types of adult chairs according to their loaded seat heights. ISO 7174-1-1988 sets standards for the forward and sidewards stability of the chair. Also in this embodiment the chair of the present invention conforms to ISO 7174-2-1992 for chairs with tilting or reclining mechanisms when fully reclined, and rocking chairs, and describes methods for determining the rearward stability of the chairs.

In a further embodiment the chair of the present invention fills all the requirements of a 24 hour chair, such that it can withstand continuous use by one user or a multitude of users, for example in a care home or hospital.

It is a further embodiment of the present invention that the self-assisting chair conforms to the standards set by the Business and Institutional Furniture Manufacturer's Association (BIFMA) that define BIFMA X5.1-2002 for testing of commercial-grade chairs, as described in TABLE 1 below.

TABLE 1
BIFMA X5.1-2002 criteria

| Test No. | Test Description | Comments |
|---|---|---|
| X5.1 - 6 | Backrest Strength | chair back strength of 150 pounds |
| | Test - Static - Type | (68 kg) and 250 lbs (104 kg) |
| | III | |
| X5.1 - 8 | Drop Test - Dynamic | seat strength of 225 pounds (102 |
| | | kg) dropped from six inches (150 |
| | | mm) above the seat |
| X5.1 - 11 | Seating Durability | seat cycle strength of 100,000 |
| | Test - Cyclic | repetitions of 125 pounds (57 kg) |
| | | dropped from 2 inches (50 mm) |
| | | above the seat |
| X5.1 - 12 | Stability Test | chair stability if weight is trans- |
| | | ferred completely to the front (135 |
| | | pounds) or back legs(173 pounds) |
| X5.1 - 13 | Arm Strength Test - | 200 pounds (91 kg) and 300 pound |
| | Vertical - Static | (136 kg) downward load to weakest |
| | | point of seating arm |
| X5.1 - 14 | Arm Strength Test - | 100 pounds (45 kg) and 150 pounds |
| | Horizontal - Static | (68 kg) inward and outward loads |
| | | applied to seating arm |
| X5.1 - 16 | Backrest Durability | 225 pounds load in seat with 75 |
| | Test - Cyclic - Type | pounds force applied to chair back - |
| | III | 120,000 cycles |
| X5.1 - 18 | Leg Strength Test - | leg strength of 75 pounds (34 kg) |
| | Front & Side Applica- | applied one inch (25 mm) from the |
| | tion | bottom of the leg |
| X5.1 - 20 | Arm Durability Test - | 90 pounds (41 kg) load to each arm |
| | Cyclic | at 10° angle, 60,000 cycles |

In yet another embodiment of the present invention, the self-assisting chair conforms to the BIFMA standards X5.4-2005 set for lounge seating and described in TABLE 2 below:

TABLE 2
BIFMA standards X5.4-2005

| Test No. | Test Description | Comments |
|---|---|---|
| X5.4-5 | Back strength - | 150 lb and 250 lb rearward loads |
| | horizontal | applied simultaneously to each |
| | | seating position of the seating back |
| X5.4-6 | Back strength - | 200 lb and 300 lb downward loads |
| | Vertical | applied simultaneously to each |
| | | seating position of the seating back |
| X5.4-7 | Back durability - | 75 lb rearward loads applied |
| | Cyclic - horizontal | simultaneously to each seating |
| | | position of the seating back for |
| | | 120,000 cycles |
| X5.4-8 | Back durability - | 200 lb downward load applied to |
| | Cyclic - vertical | the apparent weakest point of the |
| | | seating back for 10,000 cycles |
| X5.4-9 | Arm strength - | 150 lb and 200 lb inward and |
| | horizontal - Static | outward loads applied to seating arm |
| X5.4-10 | Arm strength - | 200 lb and 300 lb downward loads |
| | Vertical - Static | applied to weakest point of seating |
| | | arm |
| X5.4-11 | Arm durability - | 100 lb outward load applied to the |
| | Cyclic - horizontal | apparent weakest point of the |
| | | seating arm for 50,000 cycles |
| X5.4-12 | Arm durability - | 200 lb downward load applied to |
| | Cyclic - vertical | the apparent weakest point of the |
| | | seating arm for 10,000 cycles |
| X5.4-13 | Seating impact - | 125 lb shot filled bag dropped from |
| | Cyclic | 2″, 100,000 cycles for each |
| | | seating position |
| X5.4-14 | Drop test - Dynamic | 225 lb and 300 lb shot filled bag |
| | | dropped from 6″ for each |
| | | seating position |
| X5.4-15 | Structural durability - | 100 lb outward load applied to the |
| | Cyclic | seating at seat height with 225 lbs |
| | | in each of the seating positions |
| | | for 100,000 cycles |
| X5.4-17 | Leg strength - Front | Force equal to the weight of the |
| | and Side load - Static | unit was applied individually in |
| | | each of the required directions for |
| | | one minute |
| X5.4-18 | Unit Drop test - | End of suspended seating allowed |
| | Dynamic | to free fall to a test platform from |
| | | 12″ and 24″ heights, repeated two |
| | | additional times |
| X5.4-22.3 | Stability test - Rear - | 173 lb test mass on seat, rearward |
| | Dynamic | tipping force recorded |
| X5.4-22.4 | Stability test - | 45° forward and downward tipping |
| | Forward - Dynamic | force recorded |

The chair of the present invention appears as an aesthetically pleasing chair, in which the mechanism is hidden by the side panels of the chair. In addition the self-assist chair of the present invention meets all safety and durability requirements. Moreover, the design of the chair is both ergonomic and comfortable to the user, providing a chair that is cushioned on the seat and back as well as in the armrests of the side panels and is upholstered in a breathable fabric, while performing a useful role in assisting the user in entering and exiting the chair.

1-31. (canceled)

32. A self-assist chair comprising;
a. a chair frame portion,
b. a back rest,
c. a moveable and tiltable seat portion,
d. a track within said frame portion,
e. a roller system movable within said track; said track allowing movement of said seat portion, and
f. a spring mechanism connecting the seat portion of said chair to a horizontally moveable part of said chair frame portion,
wherein the spring mechanism includes a track guided mechanism responsive to displacement of said seat portion such that movement of said rollers on said tracks to a preset position releases said spring, thereby urging and tilting said seat portion upwards facilitating the exit of a user from said chair.

33. The chair of claim 32, wherein said spring mechanism comprises a spring element selected from the group consisting of a compression spring and an extension spring.

34. The chair of claim 32, wherein said tiltable and moveable seat portion is fixable in a position so as to prevent further unwanted movement of the seat.

35. The chair of claim 32, wherein said tiltable and moveable seat portion is attached to a horizontal panel below the seat portion by at least one articulated connection and at least one spring.

36. The chair of claim 32, wherein said at least one spring is located at any position between the seat panel and horizontal panel beneath, including randomly distributed positions, diagonal rows, front to back rows, side to side rows, at the corners of the seat or any combination thereof.

37. The chair of claim 32, wherein the seat portion, back rest and arm rests are covered in an ergonomic cushioning material, preferably egg crate foam cushion so as to prevent pressure sores.

38. The chair of claim 32, wherein the track and roller mechanism are hidden from view on each side by a side panel.

39. The chair of claim 32, wherein said seat portion is movable away from the seat back along a first track using at least one pair of attached rollers, said attached panel moves in a horizontal plane along a second track using at least two pairs of attached rollers.

40. The chair of claim 32, wherein at least two anterior cushioned and upholstered portions, joined in series to the seat portion, are movable along said second track so as to allow the seat portion to move forward and tilt, while providing protective padding for the user.

41. The chair of claim 32, wherein said seat portion is movable upward along said first track while the attached seat panel is movable in a horizontal plane away from the back rest of the chair as affected by said spring mechanism.

42. The chair of claim 32, wherein said seat portion is movable upward along said first track while the attached seat panel is movable in a horizontal plane away from the back rest of the chair as affected by said spring mechanism.

43. The chair of claim 32, wherein said seat portion is driven by said spring mechanism into a position at an angle of between about 0° and 90°, but preferably between about 40° and 70° from said horizontal panel.

44. The chair of claim 32, wherein the supporting force applied to the user by said seat portion is in a range between about 200 N and about 800 N when said user stands up from or sits down into said chair.

45. The chair of claim 44, wherein said supporting force is adjustable by said chair user.

46. The chair of claim 32, wherein said back rest is hinged to said seat portion and loosely anchored to said frame portion such that said back portion and back rest are displaceable in a swinging manner as affected by said spring mechanism.

47. The chair of claim 32, wherein said back rest is anchored by a rod mechanically connected to said frame portion; at least one elongate ear accommodating said rod is connected to said back rest at a reverse thereof such that said back rest is slidably displaceable relative to said rod.

48. In a self assisting chair, having a frame, a seat portion, with at least two connected articulated panels in the anterior portion of the seat, a backrest portion and supporting legs, is provided a spring mechanism activated by the movement of portions of the chair by rollers guided by pre-determined tracks, wherein said self-assisting chair lowers the weight load of the user by at least 40 kg.

49. A method of assisting a physically limited user in attaining a sitting position or exiting from a sitting position comprising the steps of;
a. providing a specially adapted chair, said chair further comprising
i. a moveable and tiltable seat portion,
ii. further moveable portions connected to said seat portion,
iii. tracks to guide the movement of sections of said chair along rollers,
iv. a spring;
b. supporting the user by applying a supporting force to the user by said seat portion in a range between about 200 N and about 800 N when said user stands up from or sits down into said chair;
wherein said step of supporting the user is performed by the tilting and sliding motion of the seat portion as affected by said released spring.
